(19) United States
(12) Patent Application Publication
(10) Pub. No.: US 2010/0217701 A1
(43) Pub. Date: Aug. 26, 2010

(54) System and Method for Predicting of Future Transactions in Customers Bank Account

(76) Inventor: Yossef Mesilaty, Kochav Yair (IL)

Correspondence Address: The Law Office of Michael E. Kondoudis, 888 16th Street, N.W., Suite 800, Washington, DC, 20006, US

(21) Appl. No.: 12/681,306

(22) PCT Filed: Sep. 28, 2008
(86) PCT No.: PCT/IL08/01304

§ 371 Date: Apr. 1, 2010

Related U.S. Application Data
(60) Provisional application No. 60/960,539, filed on Oct. 3, 2007.

(51) Int. Cl. G06Q 40/00; G06F 3/048

(52) U.S. Cl. 705/35; 715/764

(57) ABSTRACT

The present invention provides a computer implemented system and method enabling creating of a prediction sheet comprising various types of future predicted monetary transactions in a customer's bank account and a prediction of the futuristic monetary balance in the account at a future date or time-interval. The system enables identifying former periodic transactions in the customer's account, identifying future known transactions, analyzing the data of these identified transactions and creating the prediction sheet therefrom.

### FIELD OF THE INVENTION

The present invention relates generally to the field of computer readable methods and systems and more particularly to the field of banking related computer readable methods and systems.

### BACKGROUND OF THE INVENTION

When Checking our bank account through an internet site or a hardcopy of a sheet specifying the transactions carried out in our account over a past predefined period—most if not all transactions are transactions already carried out by the customer and/or other factors such as the bank, a credit card company, standing orders, deposited Cheques, withdrawals and the like.

For many banks' customers many of the transactions are periodic or repeat themselves over a time-span. For example, a loan transaction carried out by the customer's credit card where the payment has been divided into smaller sequential payments paid on monthly basis; in this case the payment is withdrawn from the customer's account each month along the time span set according to the transaction details, where the withdrawal transaction can be estimated quite accurately according to the transaction's details, interest rates etc. Other periodic transactions may be standing orders and/or postponed Cheques, which many customers use for bills and/or rent for example.

Today mostly credit card future known transactions can be presented to the customer, where other periodic deposits and withdrawals such as salary and rent or mortgage payments are only presented retrospectively after the transaction has already been made. This means that customers have to separately calculate the sum of expected future deposits and subtract expected future withdrawals, where one of which is the presented future credit withdrawal where the calculation has to consider the future date at which these deposits and withdrawals are to take place.

This makes planning of future monetary actions according to expected future account balances a hard task requiring careful planning and supervision over monetary activities.

### SUMMARY OF THE INVENTION

The present invention, in some embodiments thereof, provides a computer implemented system and method enabling creating of a prediction sheet comprising various types of future predicted monetary transactions in a customer's bank account and a prediction of the futuristic monetary balance in the account summing up all the transactions' deposits/withdrawals balancing in an input or a predefined future date or time-interval.

According to some embodiments of the invention, the system may enable online predicting of future transactions in a customer's bank account. The system may comprise a software application, at least one central server and at least one computerized unit operatively connected thereto, where the central server comprises at least one database comprising transaction details and account details of customers' bank accounts.

The central server may be operated by the bank, for example, to which the customers' accounts are related.

According to some embodiments of the invention, the application may enable a multiplicity of customers to view details of future transactions through said application, using customers' terminals (e.g. personal communication computerized devices such as PCs, laptops, cellular devices and the like) communicating through at least one communication network (e.g. the internet).

The application may enable identifying former periodic transactions of the customer's account (e.g. salary deposits and mortgage withdrawals); identifying known future transactions of the customer's account (e.g. credit card deposits); analyzing the details of said identified transactions; creating a prediction sheet according to the analyzed identified periodic transactions and known future transactions; and presenting said predicted future predictions in a prediction sheet.

According to some embodiments of the invention, the analyzing may be a process including processing of transactions' related data, wherein the known future transactions data is processed by said at least one central server, which is a first processing unit; retrieving said processed data from said database; and processing and analyzing said retrieved data for identifying said future known transactions and periodic transactions, wherein said computerized unit is a second processing unit.

According to some embodiments of the invention, the application may comprise a graphical user interface (GUI) enabling presenting of details of the customer's current account details, inputting information relating to current and future transactions; and presenting prediction sheets representing estimated future account details; an account module enabling retrieving customers' accounts details from the database; and a prediction module enabling to retrieve transactions' details from the account module, identify former periodic transactions, identify known future transactions and analyze said identified transactions' details to create and present a prediction sheet, which includes details of transactions predicted to occur in the customer's account.

The computerized unit may be a server and the application may be a web application, enabling a multiplicity of customers to use said application to enter their account, input parameters and view a prediction sheet of their future account.

According to some embodiments of the invention, the GUI may enable the customer to input a time-parameter, prior to creating the prediction sheet, wherein the analysis may be carried out according to said time-parameter, enabling to create a prediction sheet that includes future transactions that are predicted to occur within the time span of time-parameter.

The GUI may further enable the customer to input new future transactions' details (e.g. car related expenses, insurances, and the like), wherein said prediction module enables analyzing the identified periodic, known and inputted future transactions' details to create and include them in the prediction sheet.

According to some embodiments of the invention, the GUI may further comprise an input platform enabling the customer to input the details of new future transactions, wherein said platform may comprise
a beneficiary input box, enabling the customer to input the name of the beneficiary of the transaction;
a monetary sum box, enabling the customer to input the monetary sum of the transaction;
a type box, enabling the customer to input a description of the transaction;
a date box enabling the customer to input the date in which the transaction will be executed;
a mark box enabling the customer to define the transaction a periodic transaction; and
a cycle box, enabling the customer to define the frequency of the periodic transaction.

According to some embodiments of the invention, the application may further enable presenting the identified periodic transactions, wherein said presentation enables the customer to view periodic transactions details and to define an average parameter, which determines the number of cycles of the periodic transactions according to which the average monetary sum of the periodic transaction will be calculated.

Additionally, the application may further enable presenting a list of all identified periodic transactions allowing the customer to select periodic transactions from said list to be included in the prediction analysis and calculations.

According to some embodiments of the invention, the list of the identified periodic transactions may include:
the beneficiary of each identified periodic transaction;
the name of each identified periodic transaction;
the monetary sum of each identified periodic transaction;
the frequency cycle of each identified periodic transaction;
the account number of the customer,
a selection box enabling the customer to select transactions to be included in the prediction analysis and calculations.

According to some embodiments of the invention, the computerized unit may be operatively associated with at least one machine that enables displaying and printing of prediction sheets of customer's bank accounts.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a system for predicting future transactions in customers' bank accounts, according to some embodiments of the present invention;

FIG. 2 is a flowchart schematically describing of a method for predicting future transactions in customers' bank accounts, according to some embodiments of the present invention;

FIG. 3 is a schematic illustration of a presentation of identified periodic transactions list, according to some embodiments of the present invention;

FIG. 4 is a schematic illustration of a presentation of an input platform, according to some embodiments of the present invention;

FIG. 5 is a schematic illustration of a prediction sheet, according to some embodiments of the present invention; and

FIG. 6 is a flowchart schematically illustrating of an analysis of inputting future transactions data for producing of a prediction sheet, according to some embodiments of the present invention.

The drawings together with the description make apparent to those skilled in the art how the invention may be embodied in practice.

### DETAILED DESCRIPTIONS OF SOME EMBODIMENTS OF THE INVENTION

The present invention is a computer implemented system 1000 and method for analyzing and presenting predictions of future transactions in bank accounts of banks' customers.

The customers may also be referred to in this document also as “users” of the computerized system 1000. Each customer may have one or more bank account associated with an account number, as known in the art.

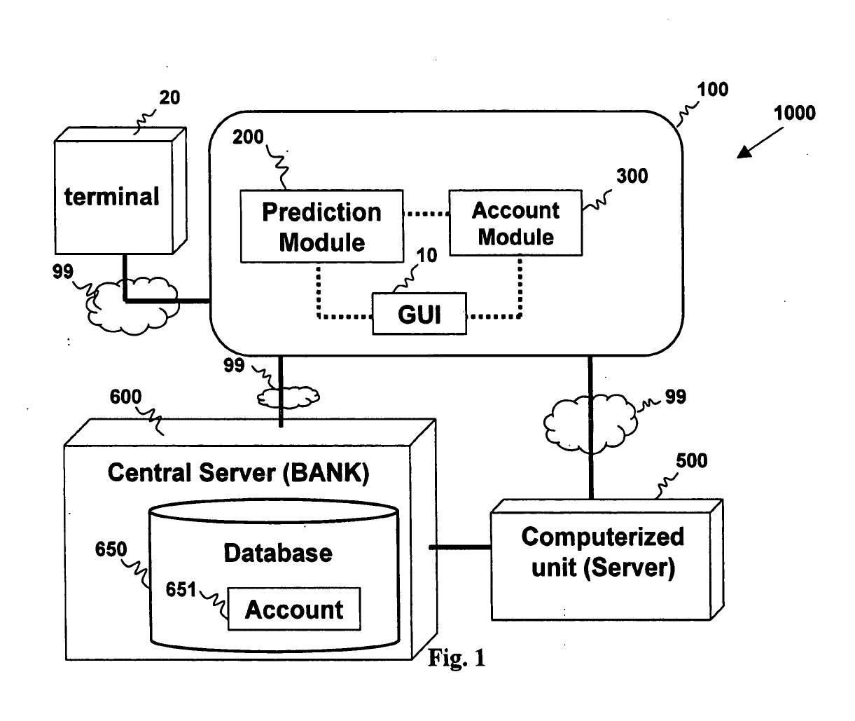

According to some embodiments of the invention, as illustrated in FIG. 1, the system 1000 may include a software application 100 such as, for example, a web application 100 ran by a web server 500, a stand-alone or a client application 100, which is ran by the customer's terminal 20, and the like, as known in the art. The application 100 may either be installed in at least one computerized unit 500 such as a server or a PC computer, for example and/or embedded in existing banking applications already running on the bank's servers. For example, the application 100 may be a web application and site or embedded in the bank's website and server 500 enabling the customers to enter their accounts and view transaction details of their accounts through the website and communicate with the bank's servers 500 through any known communication network 99 such as the internet, the WAP and the like using their communication devices, which may be computerized terminals 20 such as PCs, cellular devices, Laptops, PDAs and the like, enabling to communicate with the bank's website that includes the prediction application 100.

The server computerized unit 500 may comprise one or a multiplicity of processors arranged to operate the application 100.

According to some embodiments of the invention, the application 100 may enable real time online and/or offline (1) identifying periodic transactions in the customer's account such as the customer's salary, bills, standing orders and the like; (2) identifying of future known-transactions such as, for example, credit payments, loan payments and the like; and (3) receive input future transactions from the customer through a graphical user interface (GUI) 10 supported by the application 100.

The identification of periodic transactions in the customer's account may be carried out by identifying repeated transactions occurring within a substantially periodic time-intervals (e.g. every month or the first of every month etc.) and/or deposits/withdrawals of substantially equal sums, where the transaction is associated with the same beneficiary.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

FIG. 1 is a schematic illustration of a system 1000 for predicting future transactions in customers' bank accounts 651, according to some embodiments of the present invention.

According to some embodiments of the invention, as illustrated in FIG. 1, the system 1000 may comprise:
the application 100;
at least one computerized unit 500; and
at least one central server 600 related to the bank, for example, comprising at least one database 650, which may be a remote and/or an internal unit of the central server 600.

According to some embodiments of the invention, the application 100 may be connected to or installed in the computerized unit 500, which may be any known computerized medium such as (i) the customer's computer, laptop and the like, (ii) a web server related and maintained by the banking system or an external entity that enables customers to view their accounts and perform actions in their accounts through the customers' terminals (e.g. computers, mobile phones, etc.) and/or through a client application.

In case where the computerized unit 500 is a web server maintaining a website through the application 100, each prediction sheet may be represented in a webpage updated according to the customer's input, for example.

The computerized unit 500 may enable retrieving of data from the central server's 600 database 650 where at least some of the data stored therein may include details relating to clients' account 651 (e.g. the client's name, identification number, account number, past transactions, future known transactions (e.g. credit card future transactions), standing orders and the like.

According to some embodiments of the invention, the application 100 may comprise:
the GUI 10, enabling (i) presenting of details of the customer's current account details (e.g. already made transactions details, current cash flow and the like), (ii) inputting information relating to current and future transactions; and (iii) presenting prediction sheets representing estimated future account details;
an account module 300 enabling retrieving customers' accounts 651 details from the database 650; and
an prediction module 200 enabling retrieving and analyzing of the current and future accounts' details, (e.g. already made transactions, current cash flow, and balance, input future transactions, known future transactions and periodic transaction) and outputting a prediction of the customer's account 651 balance and details in a defined futuristic period or date.

The prediction module 200 may include one or more algorithms enabling to receive input current and future transactions details as well as retrieving past transactions' details and analyzing past transactions details to identify periodic transactions (transactions such as salary income payments, mortgage or rent expenses and the like) that are likely to occur in the future.

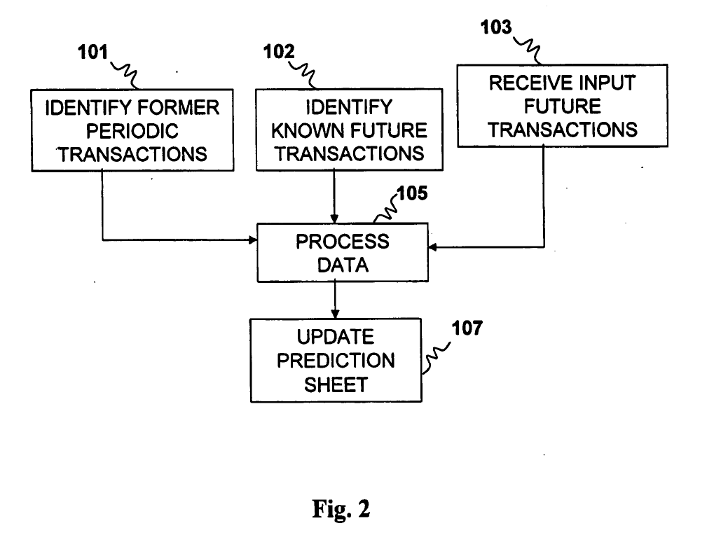

FIG. 2 is a flowchart schematically describing of a computer implemented method for predicting future transactions in a customer's bank account 651, according to some embodiments of the present invention.

The method may comprise the steps of:
identifying former periodic transactions 101 in the customer's account 651 and the details of said periodic transactions such as the transactions' frequency and monetary summation and the like;
identifying known future transaction 102 in the account 651;
receiving input future transactions from the customer 103 using the GUI 10 to input the data;
analyzing said identified and inputted data 105 using the prediction module's 200 predefined algorithm(s); and
updating a prediction sheet 107 where the application 100 may update and present the predicted future transactions along with other related information such as the future period or date, a prediction of the account-balance at that day and the like.

The analyzing process may include processing some of the transaction related data at the central server 600, for example, all data relating to past transactions and known future (e.g. credit card and future standing orders) transaction and the processing of the rest of the data such as the identification of periodic transactions and the inputted periodic and future transaction at the computerized unit 500 and/or at the customer's terminal 20.

This means that the analyzing is a process, which may include processing of transactions' related data such as the known future transactions data and former transactions may be processed by the central server 600, which is a first processing unit and the processing of the data retrieved from the central server 600 for identifying the future known transactions and the periodic transactions, is processed at the computerized unit 500, which is a second processing unit.

To identify the periodic transactions of the customer's account, the prediction module 200 may retrieve these details from the database 650 through the account module 300 and review all transactions that were executed in the account in the past predefined time-span (e.g. in the last six months).

The details such as frequency and monetary sum of periodic transactions may be used to calculate when the either equal or average sum shall be deposited or withdrawal (depending on each periodic transaction's details) according to the periodic transaction's frequency parameter value. For example, a periodic transaction such as the withdrawal of a rent, which is the same monetary sum withdrawal on the first of each month of the past last six months may be identified, analyzed an included in the future transaction of the following month prediction sheet.

Additionally, the application 100 may enable the customer to define a time-parameter (e.g. a specific day or month for the transactions sheet may predict) prior to executing the prediction calculations and algorithms, where the prediction sheet 201 may present predicted transactions according to the selected time-parameter. For example, the customer may select the future month of August 2009, where the prediction automatically outputs the prediction of all future transactions of the first of August 2009, according to selected periodic transactions, inputted transactions and other inputs and parameters. The time-parameter may also be a time interval, representing a span of dates through which future transactions are predicted and presented.

To create a prediction of a multiplicity of future transactions, the application 100 may allow the user to select periodic transactions. Once the prediction module 200 has identified the periodic transactions, a list of all identified periodic transactions 210 may be represented through the GUI 100, allowing the user to select periodic transactions to be considered in the prediction and the prediction sheet. Additionally or alternatively, all transactions identified by the prediction module 200 as periodic may be considered in the prediction calculations and analyzing.

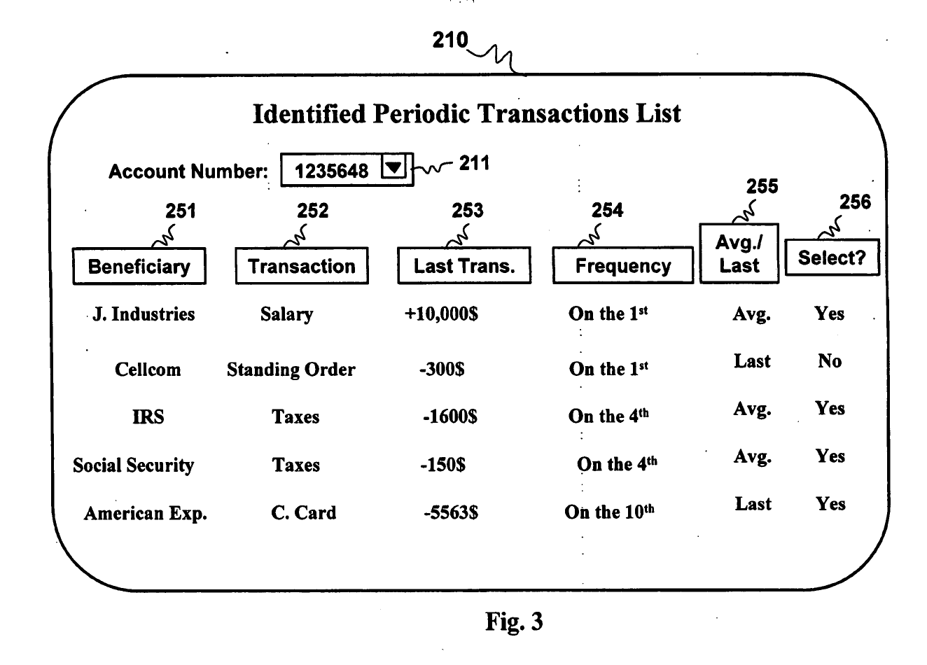

According to some embodiments of the invention, as illustrated in FIG. 3, the GUI 10 list 210 presenting all identified periodic transactions may specify the beneficiary 251 of the transaction, the transaction type 252, an average parameter, which determines the number of latest monetary sums of a former periodic transaction will be calculated as the average sum of the predicted periodic transaction; last sum 253 withdrawal/deposited in the transaction, the frequency 254 and an average/last option 255, enabling the user to define whether the periodic future predicted transaction associated with the identified periodic transaction will be calculated according to an average of a predefined number of last transactions or according to the last transaction. Additionally, the user may be allowed to choose which of the transactions may be considered in the prediction calculation and which may be left out—from the presented list of identified periodic transactions. A selection space 256 may enable the user to select the transactions, where all the transactions may be marked as “yes” as default, for example, and the user may be required to unmark the selected transaction as “No” in order to remove this transaction so that it will not be taken into account in the prediction calculations.

According to some embodiments of the invention, the application 100 may enable the user to determine the average parameter, for example, by choosing out of two options (e.g. taking the future monetary sum of the future transaction, only according to the last monetary sum of this periodic transaction or according to an average monetary sum of predefined “N” (integer number) last cycles—which are the transactions that are associated with the same periodic transaction type).

For example, the salary of the customer may have the periodic cycle of a month where the customer may select the average salary sum of the last six month, where six is the number of last cycles according to which the average salary is calculated for the next month's expected prediction.

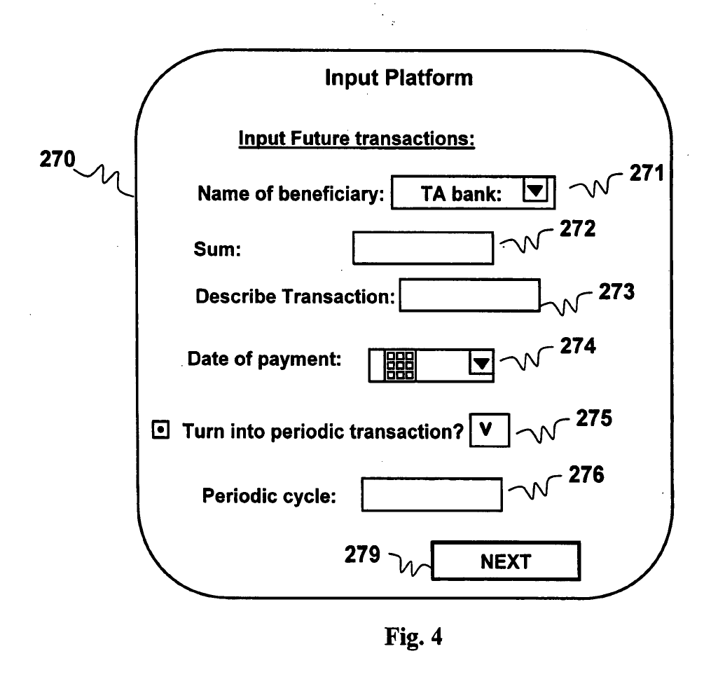

FIG. 4 is a schematic illustration of an input platform 270 of the GUI 10, according to some embodiments of the present invention, enabling the customer to input new future transactions that may not be detected by analysis of the current and past transactions. These future transactions may be, for example, transactions that have not yet been indicated in the customer's account such as postponed Cheques, virtual transactions that the customer wishes to test (and see what may be his/her account balance or status if these virtual transactions will be carried out), and the like. The customer may open the input platform 270 window through the GUI 10 option selectly.

According to some embodiments of the invention, as illustrated in FIG. 4, the input platform 270 may include:
a beneficiary input box 271, enabling the customer to input the name of the beneficiary of the transaction;
a monetary sum box 272, enabling the customer to input the monetary sum of the transaction;
a type box 273, enabling the customer to input a description of the transaction;
a date box 274 enabling the customer to input the date in which the transaction will be executed;
a mark box 275 enabling the customer to define the transaction a periodic transaction; and
a cycle box 276, enabling the customer to define the frequency of the periodic transaction.

According to some embodiments of the invention, the cycle box 276 may only allow inputting the frequency cycle of the transaction if the transaction has been defined by the customer as “periodic” by marking it as such using the mark box 275.

Additionally, the customer may move on to the next input future transaction through a virtual next button 279.

According to definitions of the input platform 270, at least some of the input transaction details may be inputted through predefined selection options that may be presented through, for example, a scroll list.

Additionally, if the user wishes to input a Cheque input transaction, the input platform 270 may include a GUI 10 option where the screen is designed like a Cheque, enabling the customer to fill in the details in a similar way to the input rubrics of a Cheque.

The GUI 10 may further allow the user to remove a periodic input or selected transaction from the sheet.

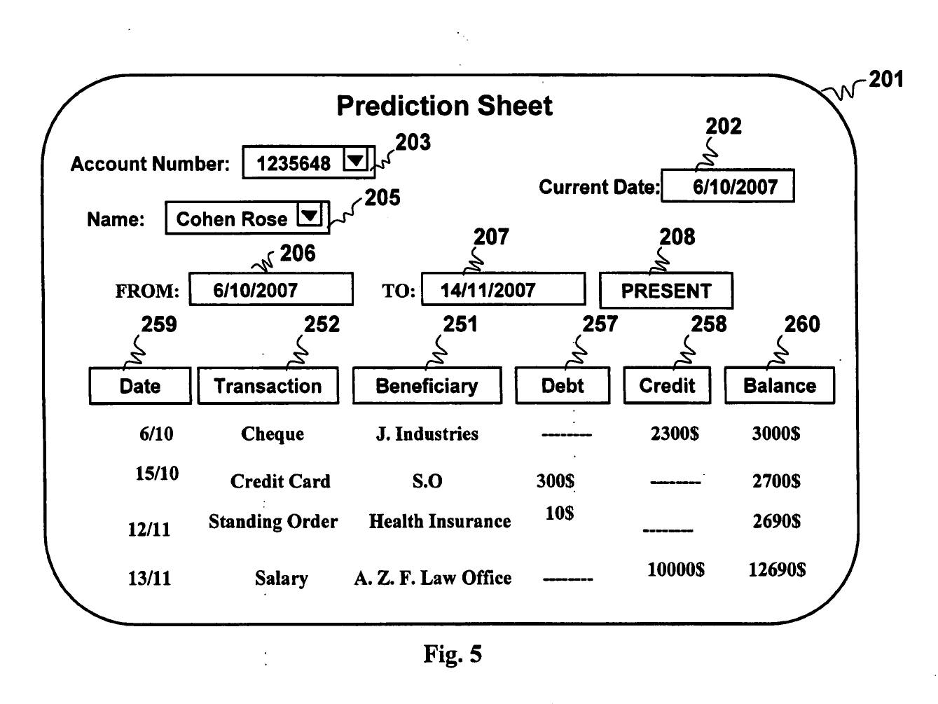

FIG. 5 schematically illustrates a prediction sheet 201 platform, according to some embodiments of the invention. The sheet 201 may enable a user to input a future period starting a selected start date 206 and ending at a selected end date 207 while exhibiting the current date 202.

Once the customer has selected the future prediction period he/she may view the details of the prediction sheet 201 by, for example, pressing a “present” 208 button. The prediction sheet 201 may further present the future date 259 of each transaction; each transaction's type 252 (e.g. a Cheque, a standing order, etc.), the beneficiary of each future transaction 251, whether the transaction is a withdrawal 257 or a deposit 258; the transactions' monetary sum; and the balance 260 as predicted according to the monetary summation of all predicted transactions.

The prediction sheet 201 may additionally present and/or allow input other details that may be, for example, the account number 203 and the customer's name 205.

According to embodiments of the invention, the GUI 10 may allow the customers to enter their account through any security mechanisms known in the art including, for example, entering his/her account through a personal code, password, user name, and the like that can only be given to the customer in his/her bank upon identification of the customer.

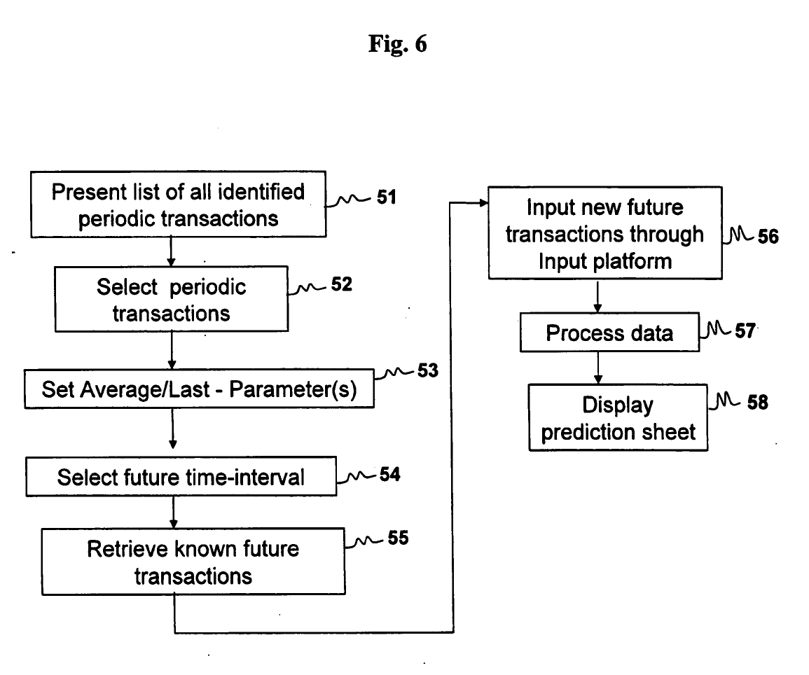

FIG. 6 is a flowchart schematically illustrating of a process of inputting future transactions data for producing of the prediction sheet 201, according to some embodiments of the present invention.

According to some embodiments of the invention, the method may comprise the steps of:
presenting 51 all periodic transactions that were identified by the prediction module 200 through the periodic transactions list 210;
selecting transactions that the customer wishes to include in the prediction 52;
Setting the average or last selections 53 for each selected periodic transaction 53;
select time-interval 54 within which the prediction processing and analyzing is carried out;
retrieve known future transactions 55 (e.g. credit card future withdrawals);
inputting new future transactions 56 where the customer may input new unknown future transactions through the input platform 270 of the GUI 10;
analyzing all transaction details (e.g. selected periodic transactions, time-interval, known and input transactions and average or last settings) 57 to produce the prediction future transactions details; and
presenting a prediction sheet 58, where the prediction shed 201 may present predicted future transaction at the selected time-interval, according to the transaction details identified, selected and retrieved in the above-mentioned former steps.

Additionally, the application 100 may enable producing more complicated predictions according to the input, periodic and known transactions such as business cash flow calculations, financial planning and the like.

Additionally or alternatively, the application 100 may enable evaluating all past transactions of the customer's account 651 (not just the periodic ones) and executing analysis including statistical calculations and evaluations according to predefined methods and algorithms, to identify patterns in the transactions of the customer's account 651. The patterns that may be identified by the application 100 may be further processed and analyzed to produce a prediction sheet 201, which may estimate other future transactions of the customer's account 651.

Withdrawals or deposits of each transaction mentioned above may be marked by minus/plus marks where, as known in the art, minus represents a withdrawal and plus represents a deposit of a monetary sum to the customer's bank account.

According to some embodiments of the invention, the computerized unit 500 may be operatively associated with one or more machines such as Automated Teller Machines (ATMs) that enable displaying and printing of prediction sheets of customer's bank accounts. The machines may also comprise an interactive interface allowing customers to identify and input their bank account numbers, time-parameters and the like.

Additionally or alternatively, the application 100 may further enable automatic online updating the monetary deposit/withdrawal sum of some of the identified periodic transactions and/or known future transactions according to rates and parameters updates. For example, if a periodic transaction is a rent, which is calculated according to US dollars but paid in another currency (e.g. IL NISs), the application 100 may enable (a) recognizing that although the monetary sum in NISs changes from one month to another, it is the same sum and beneficiary and therefore is a periodic transaction; and (b) automatically update the predicted transaction associated with the periodic/known one according to the latest currency update.

According to some embodiments of the invention, the application 100 may be installed at the computerized unit 500, which may be carry out all the calculation and analysis for producing the prediction sheets autonomously as a remote unit 500 (e.g. a web application 100 operating in a remote server 500), enabling to simultaneously carry out calculations for producing of prediction sheets for a multiplicity of users' accounts associated with a multiplicity of banks and a multiplicity of main servers 600.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A computer implemented method of predicting future transactions in a customer's bank account, using a computer implemented software application enabling the customer to view and input transaction details relating to his account, said method comprising:
identifying former periodic transactions of the customer's account;
identifying known future transactions of the customer's account;
analyzing the details of said identified transactions;
creating a prediction sheet according to the analyzed identified periodic transactions and known future transactions; and
presenting said prediction sheet,
wherein said prediction sheet comprises predicted future transactions' details and the future account balance.

2. The method of claim 1, wherein said analyzing is a process including
processing of transactions' related data, wherein the known future transactions data is processed by at least one central server, which is a first processing unit comprising a database containing all customer's bank account related data and former and future known transactions related data;
retrieving said processed data from said first processing unit; and
processing said retrieved data for identifying said future known transactions and periodic transactions, wherein said second processing is carried out by at least one computerized unit, which is a second processing unit.

3. The method of claim 1 further comprising:
presenting a list of all identified former periodic transactions; and
selecting periodic transactions out of said list, wherein said user is able to select some of said identified former periodic transactions out of said list.

4. The method of claim 3 further comprising defining a time-parameter prior to creating the prediction sheet, wherein the analysis is carried out according to said time-parameter, enabling to create a prediction sheet that includes future transactions that are predicted to occur within the time span of the time-parameter.

5. The method of claim 1 further comprising inputting new future transactions, wherein said customer inputs details of future transactions, and wherein said analysis and creation of the prediction sheet is carried out according to the analysis of all identified, known and inputted transactions associated with the customer's bank account.

6. The method of claim 5, wherein presented and inputted details of each transaction include the following details:
the beneficiary of the transaction;
the name of the transaction,
the monetary sum of the transaction;
the type of the monetary sum, which may be one of withdrawal or deposit; and
the frequency of the transaction.

7. The method of claim 6 further comprising defining an average parameter, which determines the number of latest monetary sums of a former periodic transaction will be calculated as the average sum of the periodic transaction.

8. The method of claim 7, wherein said analysis is carried out in real time and online once the time and average parameters are defined by the customer.

9. A computer implemented method of online predicting of future transactions in a customer's bank account, using a computer implemented software application enabling the customer to view and input transaction details relating to his account said method comprising:
identifying former periodic transactions of the customer's account;
presenting a list of all identified former periodic transactions;
selecting periodic transactions out of said list, wherein said user is able to select some of said identified former periodic transactions out of said list;
identifying known future transactions of the customer's account;
inputting new future transactions, wherein said customer inputs details of future transactions through a GUI option of said application;
analyzing the details of said identified, known and inputted transactions;
creating a prediction sheet according to the analyzed transactions and known future transactions; and
presenting said prediction sheet,
wherein said prediction sheet comprises all predicted future transactions' details and the future account balance calculated and analyzed according to said transactions' details.

10. A system of online predicting of future transactions in a customer's bank account,
said system comprising a software application, at least one central server and at least one computerized unit operatively connected thereto, wherein said central server comprises at least one database comprising transaction details and account details of customers' bank accounts,
said application enables a multiplicity of customers to view details of future transactions through said application, using customers' terminals,
wherein said application enables identifying former periodic transactions of the customer's account; identifying known future transactions of the customer's account; analyzing the details of said identified transactions; creating a prediction sheet according to the analyzed identified periodic transactions and known future transactions; and presenting said predicted future transactions in a prediction sheet.

11. The system of claim 10, wherein said analyzing is a process including
processing of transactions' related data, wherein the known future transactions data is processed by said at least one central server, which is a first processing unit;
retrieving said processed data from said database; and
processing and analyzing said retrieved data for identifying said future known transactions and periodic transactions, wherein said computerized unit is a second processing unit.

12. The system of claim 10, wherein said application comprises:
a graphical user interface (GUI) enabling presenting of details of the customer's current account details, inputting information relating to current and future transactions; and presenting prediction sheets representing estimated future account details;
an account module enabling retrieving customers' accounts details from the database; and
a prediction module enabling to retrieve transactions' details from the account module, identify former periodic transactions, identify known future transactions and analyze said identified transactions' details to create and present a prediction sheet, which includes details of transactions predicted to occur in the customer's account.

13. The system of claim 10, wherein said at least one computerized unit is at least one server and said application is a web application, enabling a multiplicity of customers to use said application to enter their account, input parameters and view a prediction sheet of their future account.

14. The system of claim 13, wherein said GUI enables the customer to input a time-parameter, prior to creating the prediction sheet, wherein the analysis is carried out according to said time-parameter, enabling to create a prediction sheet that includes future transactions that are predicted to occur within the time span of the time-parameter.

15. The system of claim 13, wherein said GUI further enables the customer to input new future transactions' details, wherein said prediction module enables analyzing the identified periodic, known and inputted future transactions' details to create the prediction sheet.

16. The system of claim 15, wherein said GUI comprises an input platform enabling the customer to input the details of new future transactions, wherein said platform comprises:
a beneficiary input box, enabling the customer to input the name of the beneficiary of the transaction;
a monetary sum box, enabling the customer to input the monetary sum of the transaction;
a type box, enabling the customer to input a description of the transaction;
a date box enabling the customer to input the date in which the transaction will be executed;
a mark box enabling the customer to define the transaction a periodic transaction; and
a cycle box, enabling the customer to define the frequency of the periodic transaction.

17. The system of claim 10, wherein said application further enables presenting the identified periodic transactions, wherein said presentation enables the customer to view periodic transactions details and to define an average parameter, which determines the number of cycles of the periodic transactions according to which the average monetary sum of the periodic transaction will be calculated.

18. The system of claim 10, wherein said application further enables presenting a list of all identified periodic transactions allowing the customer to select periodic transactions from said list to be included in the prediction analysis and calculations.

19. The system of claim 18, wherein said list presents:
the beneficiary of each identified periodic transaction;
the name of each identified periodic transaction;
the monetary sum of each identified periodic transaction;
the frequency cycle of each identified periodic transaction;
the account number of the customer;
a selection box enabling the customer to select transactions to be included in the prediction analysis and calculations.

20. The system of claim 10, wherein said the computerized unit is operatively associated with at least one machine that enables displaying and printing of prediction sheets of customer's bank accounts.

21. The system of claim 10, wherein said application is installed and operated by said computerized unit, wherein said computerized unit is a remote unit operatively associated with a multiplicity of main servers and banks, to enable autonomously creating of future prediction sheets to a multiplicity of customers of a multiplicity of accounts relating to a multiplicity of banks and main servers.

22. The system of claim 21, wherein said application enables simultaneous analysis of data associated with a multiplicity of customers as well as simultaneous creation of a multiplicity of prediction sheets.
